(19) United States
(12) Patent Application Publication
(10) Pub. No.: US 2026/0077286 A1
(43) Pub. Date: Mar. 19, 2026

(54) FILTER, USE OF FILTER ELEMENT IN FILTER, FILTER ELEMENT, AND MOTOR VEHICLE

(71) Applicant: MANN+HUMMEL GmbH, Ludwigsburg (DE)

(72) Inventors: Thomas SIEGELE, Benningen (DE); Mirco SCHOEN, Schauenstein (DE); Bernd JOOS, Lorch (DE); Christoph KRAUTNER, Marklkofen (DE); Mathias HÖSL, Reisbach (DE); Jens LADDACH, Dingolfing (DE); Matthias STARZER, Landau an der Isar (DE); Tobias SCHWIMMBECK, Dingolfing (DE)

(21) Appl. No.: 19/341,517

(22) Filed: Sep. 26, 2025

Related U.S. Application Data
(63) Continuation of application No. 18/320,984, filed on May 21, 2023, now Pat. No. 12,453,936.
Application No. 18/320,984 is a continuation of application No. PCT/EP2021/079374, filed on Oct. 22, 2021.

(30) Foreign Application Priority Data
Nov. 30, 2020 (DE) 102020131697.6

(51) Int. Cl. B01D 46/00; B01D 46/52; B01D 46/62; B60H 3/06

(52) U.S. Cl. CPC B01D 46/0005; B01D 46/0001; B01D 46/0002; B01D 46/0004; B01D 46/0012; B01D 46/0015; B01D 46/0036; B01D 46/521; B01D 46/62; B60H 3/0608; B01D 2265/02; B01D 2271/022; B01D 2271/025; B01D 2279/50

(57) ABSTRACT

A filter has a filter housing with a filter housing cover coupled to a filter housing part to close a receiving space configured to receive a first filter element and a second filter element each provided with a filter medium body and a frame device around the filter medium body. The filter housing has a radially projecting, circumferential contact shoulder in the receiving space. The filter housing cover, when mounted, exerts an axial clamping force on the frame device of the first filter element. The clamping force is transmitted through the frame device of the first filter element to the frame device of the second filter element. The frame device of the second filter element has a circumferential seal with a hollow chamber profile pressed by the clamping force on the contact shoulder to seal-tightly contact the contact shoulder.

### CROSS-REFERENCE TO RELATED APPLICATIONS

This application is a continuation of U.S. application Ser. No. 18/320,984 having a filing date of May 21, 2023, which is a continuation application of international application No. PCT/EP2021/079374 filed on Oct. 22, 2021, which claims the benefit of German Application No. 10 2020 131 697.6 filed on Nov. 30, 2020, the entire contents of the aforesaid applications being incorporated herein by reference.

### BACKGROUND

Embodiments concern a filter, for example a filter for the interior of a motor vehicle, as well as a use of a filter element in the filter, a filter element as well as a motor vehicle.

The increasing air pollution, for example in metropolitan areas, in connection with the use of modern air conditioning devices makes it necessary to purify by means of suitable filters the air which is guided from the exterior into the interior of a motor vehicle and processed or air-conditioned. For this purpose, for example, particle filters, odor filters, or their combination with each other are conceivable which are to filter out or adsorb as best as possible the suspended substances, particles, and odors contained in the ambient air.

For filtering air for the interior of a motor vehicle, often folded or pleated filter materials such as filter nonwovens forming a fold back are used. For this purpose, an initially flat filter material sheet is folded in a zigzag shape. The fold pack is held, for example, by lateral strips and head strips or another type of frame. Such filter elements may be fixed in an exchangeable manner in a filter receptacle. The thus formed filter assembly may be installed in an air conditioning device of a corresponding motor vehicle.

In order to fulfill the constantly increasing demands on the interior air quality, often so-called HEPA (high-efficiency particulate air) filters are used in modern motor vehicles.

For their protection and for extension of their service life, HEPA filters are often combined with a prefilter which is arranged upstream in a flow direction and which has a coarser fineness of filtration than the HEPA filter.

DE 10 2014 004 220 A1 discloses a filter element for the interior, for example for use as pesticide filter in an agricultural machine, which combines a HEPA filter element and a prefilter element. The filter element for the interior includes a frame into which the HEPA filter element and the prefilter element are glued. The frame has a circumferentially extending axial seal with a solid profile with which the filter element for the interior in a mounted state may be sealed in relation to a filter housing. The prefilter element has larger dimensions than the HEPA filter element in width and length directions. The prefilter element includes a circumferentially extending frame device by means of which it is sealed in relation to the frame. A disadvantage of this is that the HEPA filter element and the prefilter element cannot be exchanged independently of each other and that the construction with frame means a relatively large number of parts.

### SUMMARY

In view of this background, it is the object of the embodiments to provide a filter, for example a filter for an interior of a motor vehicle, with at least two filter elements in which both filter elements, for example HEPA filter element and prefilter element, may be exchanged independently of each other and which makes due with a number of parts as small as possible.

This object is solved by a filter, for example filter for the interior of a motor vehicle, including a filter housing with at least one filter housing part and a filter housing cover, wherein the filter housing includes at least one air inflow opening and one air outflow opening, respectively, and a receiving space for receiving at least two filter elements which each include a filter medium body and a frame device circumferentially extending around the filter medium body, wherein in the receiving space at least one radially inwardly projecting, circumferentially extending contact shoulder for seal-tight contact of a filter element-side seal is provided, and wherein the receiving space may be closed off by the filter housing cover which may be coupled to the filter housing part in a mounted state, wherein the filter housing cover, in the mounted state, exerts an at least partially axially directed clamping force on the frame device of a first filter element, and the frame device of the first filter element with its axial end facing away from the filter housing cover rests on the frame device of a second filter element in the mounted state, whereby the clamping force is transmitted to the frame device of the second filter element, wherein the frame device of the second filter element includes a circumferentially extending seal which is pressed by means of the clamping force on the contact shoulder of the filter housing in the mounted state, and wherein the circumferentially extending seal of the second filter element includes a hollow chamber profile.

The object is further solved by a use of a filter element as a second filter element in a filter according to the embodiments, wherein the filter element includes a filter medium body and a frame device circumferentially extending around the filter medium body, wherein a filter housing cover, in a mounted state, exerts an at least partially axially directed clamping force on a frame device of a first filter element, and the frame device of the first filter element with its axial end facing away from the filter housing cover rests against the frame device of the second filter element in the mounted state, wherein the clamping force is transmitted to the frame device of the second filter element, wherein the frame device of the second filter element includes a circumferentially extending seal which may be pressed on a contact shoulder of the filter housing by means of the clamping force in the mounted state, and wherein the circumferentially extending seal of the second filter element includes a hollow chamber profile.

The object is further solved by a filter element for a filter according to the embodiments, for example a second filter element, wherein the second filter element includes a filter medium body and a frame device circumferentially extending around the filter medium body, and wherein the frame device of the second filter element includes a circumferentially extending seal which, in a mounted state of the second filter element in the filter, may be pressed by means of a clamping force on a contact shoulder of a filter housing, and wherein the circumferentially extending seal of the second filter element includes a hollow chamber profile, and wherein the circumferentially extending seal of the second filter element provides an axially oriented contact section which is configured for seal-tight contact of a frame device of a first filter element of the filter in the mounted state, wherein the axially oriented contact section for example is provided by a circumferentially extending, radially retracted collar section of the seal of the second filter element.

Further embodiments are described in the following.

A first aspect concerns a filter, for example a filter for the interior of a motor vehicle. The filter includes a filter housing with at least one filter housing part and a filter housing cover. The filter housing includes at least one air inflow opening and one air outflow opening, respectively, and a receiving space for receiving at least two filter elements. The filter elements each include a filter medium body and a frame device circumferentially extending around the filter medium body. In the receiving space, at least one radially inwardly projecting, circumferentially extending contact shoulder for seal-tight contact of a filter element-side seal is provided. The receiving space may be closed off in a mounted state by the filter housing cover which may be coupled to the filter housing part. In the mounted state, the filter housing cover exerts at least partially an axially directed clamping force on the frame device of a first filter element. In the mounted state, the frame device of the first filter element is positioned with its axial end facing away from the filter housing cover at the frame device of a second filter element, whereby the clamping force is transmitted onto the frame device of the second filter element. The frame device of the second filter element includes a circumferentially extending seal which, in the mounted state, is pressed by means of the clamping force onto the contact shoulder of the filter housing part. According to the embodiments, the circumferentially extending seal of the second filter element includes a hollow chamber profile.

In embodiments, the first filter element and the second filter element are flowed through serially, wherein for example the second filter element is provided downstream of the first filter element.

The filter according to the embodiments has the advantage that the first filter element and the second filter element may be exchanged independently of each other in order to be able to take into account differences in service life of the two filter elements. For example, when the second filter element is a HEPA filter element and the first filter element is a corresponding prefilter element, the service life of the HEPA filter element is multiple times longer than the service life of the prefilter element. Furthermore, the filter according to the embodiments has the advantage that the number of parts is minimized. A separate frame for the two filter elements is not required; instead, they are immediately inserted into the filter housing. Furthermore, a reduction of the complexity of the system is achieved in that the filter according to the embodiments uses only a common seal for sealing the two filter elements in relation to the housing, wherein the first filter element may be sealed indirectly via the seal of the second filter element in relation to the filter housing.

A compressive strength of the seal with hollow chamber profile of the second filter element is dimensioned such that an impermissible mechanical load of the frame device of the first filter element by seal reaction forces of the seal of the second filter element is prevented.

The hollow chamber profile of the seal of the second filter element provides for a particularly high yielding action in axial direction so that even mechanically comparatively weakly dimensioned frame devices of the first filter element may transmit the required pretension forces from the filter housing cover to the frame device of the second filter element. For example when the frame device of the first filter element includes a fiber material which has only a minimal buckling resistance, the matched compressive strength of the seal of the second filter element with hollow chamber profile is an important parameter in order to ensure a reliable and permanent sealing action of the filter elements in the filter housing.

In further embodiments, the frame device of the first filter element in the mounted state may rest on a contact section of the seal of the second filter element, whereby the first filter element is sealed in relation to the second filter element.

The contact section may be provided for example by a circumferentially extending, radially retracted collar section of the seal of the second filter element.

In embodiments, the frame device of the first filter element may include a nonwoven material, wherein the nonwoven material is for example a spunbond nonwoven that includes at least a portion of synthetic fibers, for example of PET. The frame device of the first filter element may include for example so-called lateral strips and head strips which each are connected to the filter medium body, for example glued. This is a particularly inexpensive way of providing a frame device because this may be realized for various dimensions of filter medium bodies with a uniform manufacturing technology. Filter elements constructed in this way have however only minimal mechanical load strength (bending stiffness, compressive strength). However, the filter according to the embodiments is now suitable also for the indirect sealing action of such filter elements because, due to the very minimal compressive strength of the hollow chamber profile seal of the second filter element, damages of the frame device of the first filter element may be reliably precluded.

The nonwoven material of the frame device of the first filter element may include a reinforcement in order to obtain predetermined mechanical properties.

In embodiments, the nonwoven material of the frame device of the first filter element may include an air permeability at 200 Pa between about 200 l/m2s and about 2,000 l/m2s, for example between about 400 l/m2s and about 1,000 l/m2s. As an alternative or in addition, the nonwoven material of the frame device of the first filter element may have a thickness between about 0.6 mm and about 5 mm, for example between about 0.8 mm and about 2 mm. As an alternative or in addition, the nonwoven material of the frame device of the first filter element may include a weight per surface area between about 100 g/m2 and about 500 g/m2, for example between about 230 g/m2 and about 290 g/m2.

In further embodiments, the frame device of the first filter element may be embodied along a longitudinal side and/or width side of the filter medium body in a strip shape, band shape, and/or areal shape.

In embodiments, at its axial end, which is facing the filter housing cover, the frame device of the first filter element may have a rim section, at least partially in circumferential direction, which is turned over toward the filter medium body. The turned-over rim section constitutes an axially directed force introduction surface for introducing the clamping force from the filter housing cover. In embodiments in which the frame device of the first filter element includes a nonwoven material, the turned-over rim section may be designed as a so-called “L-angle section” which is formed by proverbial turning over or folding. The rim section may rest on a surface of the filter medium body. Moreover, the rim section may be delimited by a perforation or a cut from the remainder of the frame device for enabling a clean fold line upon turning over.

In yet other embodiments, the frame device of the second filter element may include a plastic frame including for example an at least partially circumferentially extending, radially projecting collar which carries the seal. For example, the radially projecting collar is provided spaced apart axially away from the axial end of the filter medium body. The plastic frame may be obtained for example by injection molding around the filter medium body (so-called plastic over-molded filter element). It is however also possible that the filter medium body is glued into the plastic frame wherein the filter medium body in this case may include its own secondary frame device, for example with lateral strips and/or head strips of a fiber material.

In embodiments, the seal of the second filter element may extend from the radially outwardly projecting collar in axial direction into a region located adjacent to the filter medium body of the second filter element so that the seal of the second filter element “overlaps”the filter medium body of the second filter element axially.

In embodiments, the seal of the second filter element may be injection molded onto the frame device, for example in a 2K molding method, or mounted as a separate part on the frame device, for example in the form of material available by the meter and to be correspondingly cut to length.

Embodiments provide that the seal of the second filter element has a compressive strength in a range of about 0.05 N/mm to about 0.7 N/mm per mm seal line, for example about 0.1 N/mm to about 0.25 N/mm per mm seal line. For a dimensioning in this compressive strength range, an impermissible mechanical load of the frame device of the first filter element, for example when the frame device includes a nonwoven material, may be prevented particularly reliably.

In embodiments, the seal of the second filter element may include in a non-compressed state an axial extension of about 10 mm to about 22 mm, for example about 14 mm to about 18 mm, and/or experience a compression of about 10% to about 40%, for example about 12% to about 20%, in the mounted state.

In embodiments, the seal of the second filter element may include an ethylene propylene diene (monomer) rubber; this is advantageous because this material is characterized by particularly minimal fogging values. In embodiments, also other elastomers, for example thermoplastic elastomers and/or polyurethanes, may be employed. Conceivable is for example an elastomer according to ISO 18064 in the version at the filing date of this application, such as rubber materials, TPE, PUR, foamed polymers, and other seal materials appearing suitable to a person of skill in the art.

According to further embodiments, the seal of the second filter element may include at least one circumferentially extending, radially projecting seal lip configured to rest in the mounted state radially seal-tightly at an inner wall of the filter housing, for example at an axially extending inner wall. By a combination of the seal lip with the (axially sealing) hollow chamber profile, a further improved sealing action of the filter elements in relation to the filter housing is obtained. The seal lip may be configured for example as a pressure-assisted seal lip whose sealing action may be increased by a differential pressure action.

Moreover, the first filter element may have a smaller dimension than the second filter element, at least in width or length direction. Dimension does not mean in this context the dimensions of the filter medium body but the absolute outer dimensions including the frame devices and seal. Since the dimensions of the first filter element are smaller than the dimensions of the second filter element, the transmission of the clamping force in accordance with the embodiments from the frame device of the first filter element to the frame device of the second filter element is simplified.

In embodiments, the dimensions of the second filter element including frame device and seal are larger than the dimensions of the first filter element including frame device, but the dimensions of the filter medium body of the second filter element are smaller than the dimensions of the first filter element.

In embodiments, the dimensions may be as follows:
First filter element (including frame device): approximately 456 mm×172 mm.
Second filter element (including frame device and seal): approximately 464 mm×180 mm.
The dimensions of the filter medium body of the second filter element may amount to approximately 441 mm×157 mm.

The height of the first filter element and/or the second filter element may lie between about 15 mm and about 35 mm, for example between about 20 mm and about 30 mm, wherein the second filter element for example has a somewhat larger height than the first filter element.

Further embodiments provide that the filter medium bodies of the first filter element and/or the second filter element include a filter medium which is pleated to a folded bellows.

In this context, a fold spacing of the folded bellows of the filter medium body of the second filter element may be smaller than a fold spacing of the folded bellows of the filter medium body of the first filter element.

In embodiments, the frame device of the first filter element at its axial end facing the second filter element may project axially past the filter medium body of the first filter element. In this way, it is ensured that the clamping force is transmitted exclusively through the frame device of the first filter element (and not through the filter medium body) and the filter medium body is not compressed which might lead to a deterioration of the filtration performance (e.g., compaction of individual folds).

In variants, the fold spacing of the folded bellows of the second filter element amounts to less than about 5 mm. A material thickness of the filter material of the folded bellows of the second filter element is between about 0.2 mm and about 1 mm, for example.

In embodiments, the filter medium body of the first filter element may include a particle filter medium and/or a gas adsorption medium and/or the filter medium body of the second filter element may include a HEPA filter medium. The HEPA filter medium may include for example a membrane of an expanding PTFE which is characterized by a particularly low pressure loss as well as is very thin and thus may be folded particularly tightly so that a very large filter surface area may be made available in the second filter element.

The filter medium of the first filter element and/or the second filter element may be embodied folded or in a corrugated shape. As folds, for example, zigzag or W folds are known. Furthermore, the filter medium may be embossed and subsequently folded sharply at embossed edges with formation of fold edges. An areal filter medium sheet may serve as starting material and is correspondingly reshaped. The filter medium may include, for example, a filter fabric, laid filter material, filter nonwoven and/or a filter membrane.

Furthermore, the filter medium of the first filter element and/or the second filter element may be of a single-layer or multilayer configuration. Furthermore, the filter medium may include an adsorption medium, such as active carbon. Furthermore, the filter medium of the first filter element and/or the second filter element may include an antimicrobial and/or anti-allergenic action. As antimicrobial substance, for example, zinc pyrithione or nanosilver, as anti-allergenic substance, for example, polyphenol, is conceivable.

The filter medium of the second filter element corresponds for example to an efficiency class of H13-H14 according to DIN EN 1822-3 in the version at the filing date of this application. The separation performance is for example greater than 99.95% (@MPPS). It may include a grammage between about 100 g/m2 and about 140 g/m2. The filter medium of the second filter element is a layer configuration which includes at least an expanded PTFE membrane which is framed at both sides by a spunbond carrier. The grammage of the PTFE membrane is for example much smaller, for example at least 10 times smaller, than the grammage of the spunbond carrier.

The filter medium of the first filter element may be a combination filter medium, i.e., a filter medium which enables a particle filtration as well as a gas adsorption. The grammage may lie between about 700 g/m2 and about 1,200 g/m2. For example, the combination filter medium includes a layer configuration, for example with an anti-microbacterial carrier (spunlaid, grammage approximately 70 g/m2), a particle filtration layer (spunbond+meltblown, grammage approximately 59 g/m2) as well as an active carbon layer enclosed thereby. The active carbon has for example a specific weight of approximately 700 g/m3 and serves as a broadband adsorber. For example, a mixture of various active carbon types may be present in the active carbon layer, e.g., two thirds of the active carbon may be catalytically activated and one third of the active carbon may be impregnated with phosphoric acid.

A further aspect of the embodiments concerns a use of a filter element as a second filter element in a filter according to the embodiments. The second filter element has a filter medium body and a frame device circumferentially extending around the filter medium body, wherein a filter housing cover of the filter in a mounted state exerts an at least partially axially directed clamping force on a frame device of a first filter element. In the mounted state, the frame device of the first filter element rests in this context with its axial end facing away from the filter housing cover at the frame device of the second filter element, wherein the clamping force is transmitted to the frame device of the second filter element. The frame device of the second filter element includes a circumferentially extending seal which, in the mounted state, may be pressed by means of the clamping force onto a contact shoulder of the filter housing. The circumferentially extending seal of the second filter element includes a hollow chamber profile, wherein for example a compressive strength of the seal with hollow chamber profile is dimensioned such that an impermissible mechanical load of the frame device of the first filter element by seal reaction forces is prevented.

Finally, yet another aspect of the embodiments concerns a filter element for a filter according to the embodiments, for example a second filter element for a filter. The second filter element includes a filter medium body and a frame device circumferentially extending around the filter medium body. The frame device of the second filter element includes a circumferentially extending seal which, in the mounted state of the second filter element in the filter, may be pressed by means of a clamping force onto a contact shoulder of the filter housing. The circumferentially extending seal of the second filter element includes a hollow chamber profile. The circumferentially extending seal provides an axially directed contact section which is configured for seal-tight contact of a frame device of a first filter element of the filter in the mounted state, wherein the axially directed contact section is provided for example by a circumferentially extending, radially retracted collar section of the circumferentially extending seal of the second filter element.

All features, feature combinations, and advantages disclosed in regard to the filter according to the embodiments may be applied to the use according to the embodiments as well as to the filter elements according to the embodiments, and vice versa.

Further possible implementations of the embodiments include also combinations, not explicitly mentioned, of features or method steps described before or in the following with respect to the embodiments. In this context, a person of skill in the art will also add individual aspects as improvements or supplements to the respective basic form of the embodiments.

In the following, the embodiments will be explained in more detail with reference to the attached drawing figures.

### BRIEF DESCRIPTION OF DRAWINGS

FIG. 1 shows a schematic illustration of a motor vehicle according to the embodiments.

FIG. 2 shows an isometric view of a filter according to the embodiments.

FIG. 3 shows a longitudinal section of a filter according to the embodiments.

FIG. 4 shows detail B according to FIG. 3.

FIG. 5 shows an isometric view of a filter element according to the embodiments.

FIG. 6 shows a longitudinal section of a filter element according to the embodiments.

### DETAILED DESCRIPTION

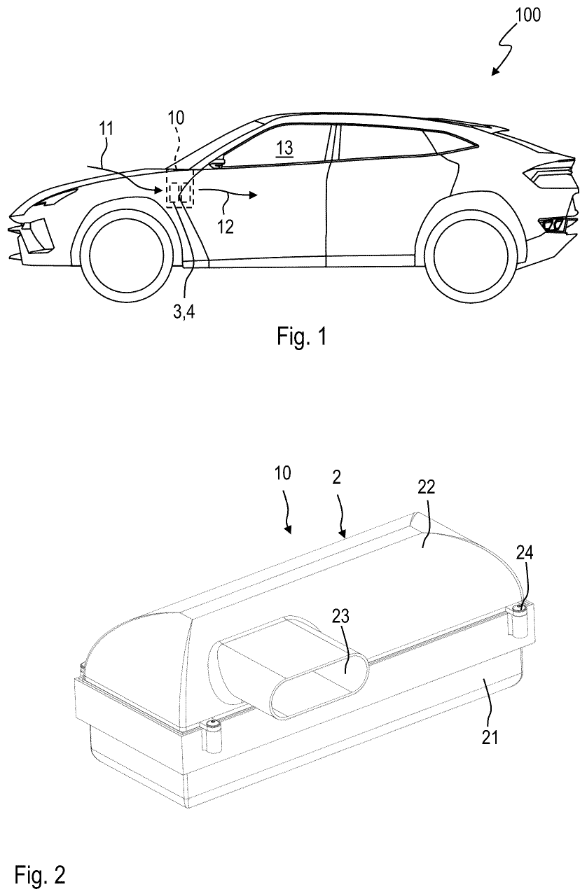

In FIG. 1, a motor vehicle 100 according to the embodiments is shown in a schematic illustration. The motor vehicle 100 comprises a filter 10 for the interior in accordance with the embodiments by means of which raw air 11 originating from the exterior is purified and may be supplied as clean air 12 to the interior 13 of the motor vehicle 100. The filter 10 for the interior has two filter elements, a first filter element 3 and a second filter element 4, which may be flowed through for example serially. The second filter element 4 may be a HEPA filter element and the first filter element 3 may be a prefilter element which is matched with respect to its filtration parameters to the HEPA filter element.

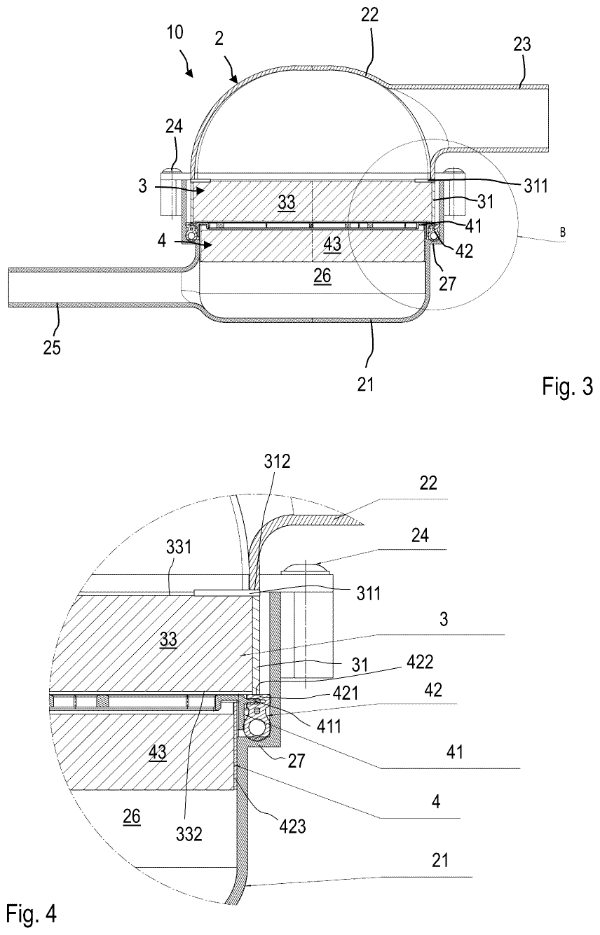

The filter 10 for the interior 13 according to the embodiments is illustrated in FIG. 2 in an isometric view. The filter 10 for the interior 13 has a filter housing 2 with a filter housing part 21 and a filter housing cover 22 which closes off the filter housing 2. The filter housing cover 22 is detachably connected by connector elements 24, here screws, to the filter housing part 21 so that in a servicing situation the filter elements contained therein may be exchanged. The filter housing 2 has an inlet opening 23 as well as an outlet opening 25 (see FIG. 3). Through the inlet opening 23 unfiltered raw air may be supplied to the filter housing 2 and through the outlet opening filtered clean air may be discharged from the filter housing 2. In the filter housing 2, two filter elements 3, 4 are arranged which filter the air, which is illustrated in the longitudinal section of FIG. 3.

The filter housing 2 provides a receiving space 26 in which the first filter element 3 as well as the second filter element 4 are arranged. In operation of the filter 10, the filter elements 3, 4 are flowed through serially, i.e., the air flow is guided from the inlet opening 23 through the first filter element 3, then through the second filter element 4 all the way to the outlet opening 25.

The filter elements 3, 4 each comprise a frame device 31, 41 as well as a filter medium body 33, 43, wherein the filter medium bodies 33, 43 comprise for example a filter medium folded to a folded bellows.

The frame device 31 of the first filter element 3 comprises a strip-shaped nonwoven material which is connected to the filter medium body 33 of the first filter element 3. The frame device 31 is comprised of so-called head strips and lateral strips. This filter element configuration has the advantage that it may be produced particularly inexpensively; however, it is mechanically loadable only to a very limited extent, for example due to minimal bending stiffness and compressive strength.

The frame device 41 of the second filter element 4 comprises a plastic frame to which the filter medium body 43 of the second filter element 4 is connected. The filter medium body 43 of the second filter element 4 comprises a secondary frame device 423 which—like the first filter element 3—comprises a strip-shaped nonwoven material, the so-called head strips and lateral strips. The filter medium body 43 is glued to the plastic frame of the frame device 41 of the second filter element 4 or connected in a different manner appearing suitable to a person of skill in the art. As an alternative, the second filter element 4 may also be a plastic over-molded filter element (not illustrated) in which the secondary frame device 423 may be dispensed with because the frame device 41 is joined directly by material fusion to the filter medium body 43 by the over-molding process.

The frame device 41 of the second filter element 4 comprises a circumferentially extending seal 42 which comprises a hollow chamber profile which comprises a particularly minimal compressive strength.

In the illustrated mounted state of the filter 10, a clamping force from the filter housing cover 22 is introduced into the frame device 31 of the first filter element 3 at an axial end of the frame device 31 of the first filter element 3 which is proximal to the filter housing cover 22. The frame device 31 of the first filter element 3 rests with its axial end facing away from the filter housing cover 22 on the frame device 41 of the second filter element 4 and transmits the clamping force. In this way, the circumferentially extending seal 42 of the second filter element 4 is brought into seal-tight contact at the radially inwardly projecting, circumferentially extending contact shoulder 27 of the filter housing part 21 at a predetermined compression.

The first filter element 3 does not comprise its own seal in relation to the filter housing 2 but is indirectly sealed by the seal 42 of the second filter element in relation to the filter housing 2.

The interface between the first filter element and the second filter element 3, 4 as well as the filter housing part 21 and the filter housing cover 22 is illustrated in detail B in FIG. 4 at a somewhat larger scale.

At its axial end which is proximal to the filter housing cover 22, the frame device 31 of the first filter element 3 comprises a rim section 311 which is turned over toward the filter medium body 33 and provides an axially directed force introduction surface 312 for introducing the clamping force from the filter housing cover 22. The rim section 311 rests on an inflow-side surface 331 of the filter medium body 33 and contributes to increasing the stiffness of the first filter element 3 as a whole; this is advantageous for example under the action of the clamping force.

At its axial end which is facing away from the filter housing cover 22, the frame device 31 of the first filter element 3 projects past the filter medium body 33 at an outflow-side surface 332 so that it is ensured that the clamping force is transmitted exclusively through the frame device 31 of the first filter element 3 to the frame device 41 of the second filter element 4 and not through a contact of sections of the filter medium body 33 of the first filter element 3.

The circumferentially extending seal 42 of the frame device 41 of the second filter element 4 comprises a contact section 422 which is provided by a radially retracted collar section 421 of the seal 42. The frame device 31 of the first filter element 3 axially rests on this contact section 422 and transmits the clamping force. Since the collar section 421 is comprised of the material of the seal 42, the first filter element 3 is sealed at the same time indirectly in relation to the filter housing 2 in this way, in addition to a transmission of the clamping force.

The circumferentially extending seal 42 which comprises the hollow chamber profile is mounted on a radially projecting collar 411 of the frame device 41 of the second filter element 4 and is axially compressed in relation to a radially oriented wall of the contact shoulder 27 of the filter housing part 21 in the mounted state. The seal 42 is received in sort of a chamber of the filter housing part 21, wherein the chamber is formed by the contact shoulder 27 and an axially extending wall section of the filter housing part 21. In this context, the axially extending wall section prevents an excessive radial “escape” of the seal under the action of the clamping force, which escape could reduce the sealing action. In embodiments (not illustrated), the circumferentially extending seal 42 may have at least one radially projecting seal lip which may be brought into radial seal-tight contact at the axially extending wall section; this has the potential of further improving the sealing action. The illustrated contour of the seal 42 comprises no decided lip geometry but rests radially outwardly at the axially extending wall section in the region of the plane of the radially projecting collar 411 of the frame device 41.

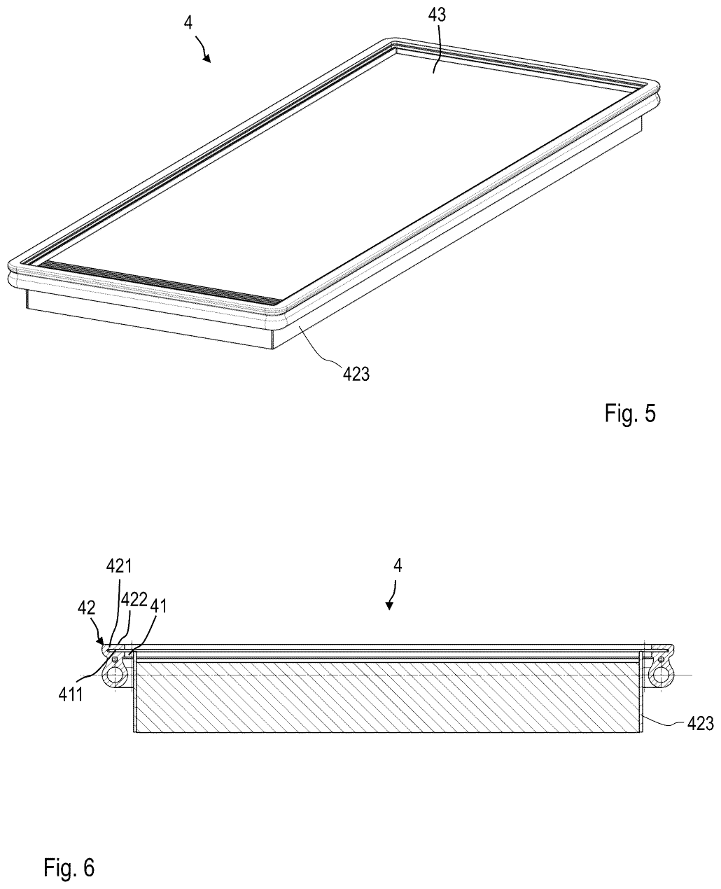

In FIGS. 5 and 6, a filter element 4 according to the embodiments is illustrated which is the second filter element 4 of the filter 10 according to the embodiments. Here, embodiments of the filter medium body 43 as a pleated folded bellows are indicated; however, the embodiments are expressly not limited to this.

That which is claimed is:

1. A filter comprising:
a filter housing comprising a receiving space within the filter housing,
wherein the receiving space is configured to receive at least a first filter element and a second filter element, each of the first filter element and the second filter element comprising a filter medium body and a frame device circumferentially extending around the filter medium body,
wherein the filter housing further comprises at least one radially projecting, circumferentially extending contact shoulder disposed in the receiving space,
wherein the filter housing in a mounted state, exerts an at least partially axially directed clamping force on the frame device of the first filter element, the frame device of the first filter element resting on the frame device of the second filter element in the mounted state, and the clamping force being transmitted through the frame device of the first filter element to the frame device of the second filter element,
wherein the frame device of the second filter element comprises a circumferentially extending seal configured to seal-tightly contact the at least one radially projecting, circumferentially extending contact shoulder of the filter housing, the circumferentially extending seal being pressed by the clamping force on the at least one radially projecting, circumferentially extending contact shoulder of the filter housing in the mounted state.

2. The filter according to claim 1, wherein the circumferentially extending seal comprises a hollow chamber profile.

3. The filter according to claim 1, wherein the frame device of the first filter element is configured to rest on a contact section of the circumferentially extending seal in the mounted state, the first filter element being sealed in relation to the second filter element.

4. The filter according to claim 3, wherein the circumferentially extending seal comprises a circumferentially extending, radially retracted collar section providing the contact section for the frame device of the first filter element.

5. The filter according to claim 1, wherein the frame device of the first filter element comprises a nonwoven material.

6. The filter according to claim 5, wherein a longitudinal side of the frame device of the first filter element and/or a width side of the frame device of the first filter element is embodied in any one or any combination of a strip shape, a band shape, and an areal shape.

7. The filter according to claim 1, wherein the frame device of the first filter element comprises an axial end facing a filter housing cover of the filter housing and having a rim section extending at least partially in a circumferential direction, and wherein the rim section is turned over toward the filter medium body of the first filter element to provide an axially directed force introduction surface configured to introduce the clamping force from the filter housing cover into the frame device of the first filter element.

8. The filter according to claim 1, wherein the frame device of the second filter element comprises a plastic frame, and
wherein the plastic frame comprises an at least partially circumferentially extending, radially projecting collar carrying the circumferentially extending seal, and the at least partially circumferentially extending, radially projecting collar being spaced apart in an axial direction from an axial end of the filter medium body of the second filter element.

9. The filter according to claim 8, wherein the circumferentially extending seal extends from the at least partially circumferentially extending, radially projecting collar in the axial direction into a region positioned adjacent to the filter medium body of the second filter element.

10. The filter according to claim 1, wherein the circumferentially extending seal is injection molded to the frame device of the second filter element or is mounted as a separate part onto the frame device of the second filter element.

11. The filter according to claim 1, wherein the circumferentially extending seal comprises ethylene propylene diene rubber.

12. The filter according to claim 1, wherein a compressive strength of the circumferentially extending seal is dimensioned such that an impermissible mechanical load of the frame device of the first filter element by seal reaction forces of the circumferentially extending seal is prevented.

13. The filter according to claim 1, wherein the first filter element comprises, at least in a width direction of the first filter element or a length direction of the first filter element, a smaller length dimension or a smaller width dimension than the second filter element.

14. The filter according to claim 1, wherein the filter medium body of the first filter element and/or the filter medium body of the second filter element comprises a filter medium pleated to a folded bellows.

15. The filter according to claim 1, wherein the filter medium body of the first filter element comprises a filter medium pleated to a folded bellows,
wherein the filter medium body of the second filter element comprises a filter medium pleated to a folded bellows, and
wherein a fold spacing of the folded bellows of the filter medium body of the second filter element is smaller than a fold spacing of the folded bellows of the filter medium body of the first filter element.

16. The filter according to claim 1, wherein an axial end of the frame device of the first filter element facing away from a filter housing cover of the filter housing projects axially past the filter medium body of the first filter element.

17. The filter according to claim 1, wherein the filter medium body of the first filter element comprises a particle filter medium and/or a gas adsorption medium, and/or
wherein the filter medium body of the second filter element comprises a HEPA filter medium.

18. A method comprising:
arranging a first filter element, comprising a filter medium body and a frame device circumferentially extending around the filter medium body, in a receiving space of a filter housing;
arranging a second filter element, comprising a filter medium body and a frame device circumferentially extending around the filter medium body, in the receiving space of the filter housing;
providing the frame device of the second filter element with a circumferentially extending seal;
positioning the frame device of the first filter element on the frame device of the second filter element;
exerting with the filter housing an at least partially axially directed clamping force on the frame device of the first filter element;
transmitting the clamping force through the frame device of the first filter element to the frame device of the second filter element; and
pressing the circumferentially extending seal by the clamping force on a radially projecting, circumferentially extending contact shoulder of the filter housing disposed in the receiving space and commonly sealing the first filter element and the second filter element in relation to the filter housing by the circumferentially extending seal.

19. A filter element as the second filter element for the filter according to claim 1, wherein the second filter element comprises:
the filter medium body; and
the frame device circumferentially extending around the filter medium body, and comprising the circumferentially extending seal configured to, in the mounted state, be pressed by the clamping force on the contact shoulder of the filter housing of the filter, the circumferentially extending seal comprising an axially oriented contact section configured to seal-tightly contact the frame device of the first filter element of the filter in the mounted state, with the axially oriented contact section being a circumferentially extending, radially retracted collar section of the circumferentially extending seal of the frame device of the second filter element.

20. A motor vehicle comprising the filter according to claim 1.
